(19) United States
(12) Patent Application Publication
(10) Pub. No.: US 2018/0355175 A1
(43) Pub. Date: Dec. 13, 2018

(54) COMPOSITION FOR WINDOW FILM, FLEXIBLE WINDOW FILM FORMED THEREFROM, AND FLEXIBLE DISPLAY DEVICE COMPRISING SAME

(71) Applicants: SAMSUNG SDI CO., LTD., Yongin-si Gyeonggi-do (KR); SAMSUNG ELECTRONICS CO., LTD., Suwon-si Gyeonggi-do (KR)

(72) Inventors: Dong Il HAN, Suwon-si (KR); Kyoung Ku KANG, Suwon-si (KR); Min Hye KIM, Suwon-si (KR); Ji Hwan PARK, Suwon-si (KR); Chang Soo WOO, Suwon-si (KR); Ji Sun IM, Suwon-si (KR); Seung Woo JANG, Suwon-si (KR)

(21) Appl. No.: 15/776,771

(22) PCT Filed: Sep. 6, 2016
(86) PCT No.: PCT/KR2016/009936

§ 371 Date: May 16, 2018

(30) Foreign Application Priority Data
Nov. 20, 2015 (KR) 10-2015-0163607

(51) Int. Cl. C08L 83/04; C08J 5/18; C08K 5/151; C09J 7/20; G09F 9/30

(52) U.S. Cl. CPC C08L 83/04; C08J 5/18; G09F 9/30; C09J 7/20; C08K 5/151

(57) ABSTRACT

Provided is a composition for window films comprising a siloxane resin of formula 1, a crosslinking agent and an initiator, a flexible window film formed therefrom, and a flexible display device comprising the same. (R¹SiO_{3/2})ₓ(R²SiO_{3/2})_{y}(R³R⁴SiO_{2/2})_{z}(SiO_{4/2})w (in formula 1, R¹ is a functional group containing an alicyclic epoxy group, R² is a functional group containing a glycidyl group, R³ and R⁴ are each independently a hydrogen, a functional group containing an alicyclic epoxy group, a functional group containing a glycidyl group, an optionally substituted C₁ to C₂₀ alkyl group, an optionally substituted C₅ to C₂₀ cycloalkyl group or an optionally substituted C₆ to C₂₀ aryl group, wherein 0<x<1, 0<y≤0.5, 0≤z<1, 0≤w<1, and x+y+z+w=1).

### CROSS-REFERENCE TO RELATED APPLICATIONS

This application is a National Phase Patent Application and claims priority to and the benefit of International Application Number PCT/KR2016/009936, filed on Sep. 6, 2016, which claims priority to and the benefit of Korean Patent Application No. 10-2015-0163607, filed on Nov. 20, 2015, the entire contents of each of which are incorporated herein by reference.

### BACKGROUND

### 1. Field

The present invention relates to a composition for window films, a flexible window film formed of the same, and a flexible display including the same.

### 2. Description of the Related Art

Recently, flexible displays capable of being folded and unfolded have been developed. For such a flexible display, not only a substrate but also various other components included in the display need to have flexibility. In particular, a window film needs to have good flexibility and good flexural reliability so as not to crack even when bent repeatedly. Such a window film is prepared by coating a coating layer composition onto a base layer, followed by curing, and thus can suffer from curling.

The background technique of the present invention is disclosed in Japanese Patent Publication No. 2007-176542.

### SUMMARY

It is one aspect of the present invention to provide a composition for window films which can realize an optically transparent flexible window film having high hardness, good flexibility, and low curling.

It is another aspect of the present invention to provide a composition for window films which can realize a flexible window film having good flexural reliability.

In accordance with one aspect of the present invention, a composition for window films includes: a siloxane resin represented by Formula 1; a crosslinking agent; and an initiator.

(R¹SiO_{3/2})ₓ(R²SiO_{3/2})_{y}(R³R⁴SiO_{2/2})_{z}(SiO_{4/2})_{w} <Formula 1>

(wherein Formula 1, R¹, R², R³, R⁴, x, y, z and w are as defined in the following detailed description of the invention.)

In accordance with another aspect of the present invention, a flexible window film includes a base layer and a coating layer formed on the base layer, wherein the flexible window film may be formed of the composition for window films according to the present invention.

In accordance with a further aspect of the present invention, a flexible display includes the flexible window film set forth above.

The present invention provides a composition for window films which can realize an optically transparent flexible window film having high hardness, good flexibility, and low curling.

In addition, the present invention provides a composition for window films which can realize a flexible window film having good flexural reliability.

### BRIEF DESCRIPTION OF THE DRAWINGS

FIG. 1 is a sectional view of a flexible window film according to one embodiment of the present invention.

FIG. 2 is a sectional view of a flexible window film according to another embodiment of the present invention.

FIG. 3 is a sectional view of a flexible display according to one embodiment of the present invention.

FIG. 4 is a sectional view of one embodiment of a display part shown in FIG. 3.

FIG. 5 is a sectional view of a flexible display according to another embodiment of the present invention.

FIG. 6 is a schematic diagram illustrating measurement of curling.

### DETAILED DESCRIPTION

Embodiments of the present invention will be described in detail with reference to the accompanying drawings. It should be understood that the present invention may be embodied in different ways and is not limited to the following embodiments. In the drawings, portions irrelevant to the description will be omitted for clarity. Like components will be denoted by like reference numerals throughout the specification.

As used herein, spatially relative terms such as “upper” and “lower” are defined with reference to the accompanying drawings. Thus, it will be understood that the term “upper surface” can be used interchangeably with the term “lower surface”. When an element or layer is referred to as being “on,” “connected to,” or “coupled to” another element or layer, it can be directly on, connected to, or coupled to the other element or layer or intervening elements or layers may be present. However, when an element or layer is referred to as being “directly on,” “directly connected to,” or “directly coupled to” another element or layer, there are no intervening elements or layers present.

As used herein, the term “(meth)acrylic” refers to acrylic and/or methacrylic.

As used herein, the term “alicyclic epoxy group-containing functional group” refers to an alicyclic epoxy group-containing substituted or unsubstituted C₁ to C₂₀ alkyl group, an alicyclic epoxy group-containing substituted or unsubstituted C₅ to C₂₀ cycloalkyl group, or an alicyclic epoxy group-containing substituted or unsubstituted C₆ to C₂₀ aryl group, wherein the “alicyclic epoxy group” may be an epoxidized C₅ to C₂₀ cycloalkyl group, for example, an epoxycyclohexyl group. As used herein, the term “glycidyl group-containing functional group” refers to a glycidoxy group, a glycidyl group or glycidoxy group-containing substituted or unsubstituted C₁ to C₂₀ alkyl group, a glycidyl group or glycidoxy group-containing substituted or unsubstituted C₅ to C₂₀ cycloalkyl group, or a glycidyl group or glycidoxy group-containing substituted or unsubstituted C₆ to C₂₀ aryl group. As used herein, unless otherwise stated, the term “substituted” means that at least one hydrogen atom of a functional group is substituted with a hydroxyl group, an unsubstituted C₁ to C₁₀ alkyl group, a C₁ to C₁₀ alkoxy group, a C₃ to C₁₀ cycloalkyl group, an unsubstituted C₆ to C₂₀ aryl group, a C₇ to C₂₀ arylalkyl group, a C₆ to C₂₀ aryl group substituted with a C₁ to C₁₀ alkyl group, or a C₁ to C₁₀ alkyl group substituted with a C₁ to C₁₀ alkoxy group. As used herein, “halogen” refers to fluorine, chlorine, bromine or iodine. As used herein, “Ec” denotes a 2-(3,4-epoxycyclohexyl)ethyl group, “Gp” denotes a 3-glycidoxypropyl group, “Me” denotes a methyl group, “Et” denotes an ethyl group, and “Ph” denotes a phenyl group.

Hereinafter, a composition for window films according to one embodiment of the present invention will be described. A composition for window films according to this embodiment may include a siloxane resin represented by Formula 1, a crosslinking agent, and an initiator:

(R¹SiO_{3/2})ₓ(R²SiO_{3/2})_{y}(R³R⁴SiO_{2/2})_{z}(SiO_{4/2})_{w} <Formula 1>

(wherein R¹ is an alicyclic epoxy group-containing functional group, R² is a glycidyl group-containing functional group, R³ and R⁴ are each independently hydrogen, an alicyclic epoxy group-containing functional group, a glycidyl group-containing functional group, an unsubstituted or substituted C₁ to C₂₀ alkyl group, an unsubstituted or substituted C₅ to C₂₀ cycloalkyl group, or an unsubstituted or substituted C₆ to C₂₀ aryl group, 0<x<1, 0<y≤0.5, 0≤z<1, 0≤w<1, and x+y+z+w=1).

The composition for window films according to this embodiment includes the siloxane resin represented by Formula 1 and thus can realize a window film which exhibits good properties in terms of pencil hardness, appearance and transparency, has low radius of curvature, good flexibility, and low curling, and has sufficiently high hardness without nanoparticles of oxides or the like. Specifically, in Formula, y may be in the range of 0<y≤0.5, 0<y≤0.3, or 0<y≤0.2, more specifically 0.01≤y≤0.15. Within this range, the composition for window films can realize a window film which has high hardness, low curling, and good flexural reliability. Particularly, in the range of 0.01≤y≤0.15, a window film having good optical transparency can be realized due to a small difference in index of refraction between the composition for window films and a base layer coated with the composition. Specifically, R¹ may be an alicyclic epoxy group-containing unsubstituted or substituted C₁ to C₁₀ alkyl group, more specifically an epoxycyclohexylethyl group or an epoxycyclohexylmethyl group. Specifically, R² may be a glycidoxy group-containing unsubstituted or substituted C₁ to C₁₀ alkyl group, more specifically a glycidoxypropyl group. Specifically, R³ and R⁴ may each independently be a methyl group, an ethyl group, a phenyl group, a (3,4-epoxycyclohexyl)methyl group, a (3,4-epoxycyclohexyl)ethyl group, a (3,4-epoxycyclohexyl)propyl group, or a glycidoxypropyl group. The siloxane resin represented by Formula 1 may have a weight average molecular weight of about 1,000 to about 10,000, specifically about 4,000 to about 10,000, more specifically about 4,000 to about 7,000, for example, 4,000, 4,500, 5,000, 5,500, 6,000, 6,500, or 7,000. Within this range, the siloxane resin can support a coating layer of a window film. The siloxane resin represented by Formula 1 may have a polydispersity index (PDI) of about 1.0 to about 4.0, specifically about 1.5 to about 3.0 and an epoxy equivalent of about 0.1 mol/100 g to about 1.0 mol/100 g, specifically about 0.3 mol/100 g to about 0.8 mol/100 g, for example, 0.3 mol/100 g, 0.4 mol/100 g, 0.5 mol/100 g, 0.6 mol/100 g, 0.7 mol/100 g, or 0.8 mol/100 g. When the polydispersity index and epoxy equivalent of the siloxane resin fall within these ranges, the composition for window films can exhibit good coatability and stable coating properties.

Next, specific examples of the siloxane resin represented by Formula 1 will be described.

In one embodiment, the siloxane resin represented by Formula 1 may be a siloxane resin including a T unit and a T unit, as represented by Formula 1-1:

(R¹SiO_{3/2})ₓ(R²SiO_{3/2})_{y}< Formula 1-1>

(wherein Formula 1-1, R¹ and R² are as defined in Formula 1, 0.5≤x≤1, 0<y≤0.5, and x+y=1).

In Formula 1-1, x and y are in the ranges of 0.70≤x<1 and 0<y≤0.30, specifically 0.80≤x<1 and 0<y≤0.20, more specifically 0.85≤x≤0.99 and 0.01≤y≤0.15. Within these ranges, the composition can realize a window film which has high hardness, low radius of curvature, good flexibility, low curling, and good flexural reliability. Specifically, the siloxane resin represented by Formula 1-1 may be (EcSiO_{3/2})ₓ(GpSiO_{3/2})_{y}.

In another embodiment, the siloxane resin represented by Formula 1 may be a siloxane resin including a T unit, a T unit, a D unit, and a Q unit, as represented by Formula 1-2:

(R¹SiO_{3/2})ₓ(R²SiO_{3/2})_{y}(R³R⁴SiO_{2/2})_{z}(SiO_{4/2})_{w}< Formula 1-2>

(wherein Formula 1-2, R¹, R², R³ and R⁴ are as defined in Formula 1, 0<x<1, 0<y≤0.5, 0<z<1, 0<w<1, and x+y+z+w=1). In Formula 1-2, x, y, z and w are in the ranges of 0.10≤x<1, 0<y≤0.30, 0<z≤0.20, and 0<w≤0.40, more specifically 0.40≤x<1, 0<y≤0.20, 0<z≤0.10, and 0<w≤0.30, still more specifically 0.60≤x≤0.95, 0.01≤y≤0.15, 0.01≤z≤0.05, and 0.01≤w≤0.20. Within these ranges, the composition can realize a window film which has high hardness, low radius of curvature, good flexibility, low curling, and good flexural reliability. Specifically, the siloxane resin represented by Formula 1-2 may be any one of Formulae 1-2A to 1-2E, without being limited thereto.

(EcSiO_{3/2})ₓ(GpSiO_{3/2})_{y}(EcMeSiO_{2/2})_{z}(SiO_{4/2})_{w} <Formula 1-2A>

(EcSiO_{3/2})ₓ(GpSiO_{3/2})_{y}((Me)₂SiO_{2/2})_{z}(SiO_{4/2})_{w} <Formula 1-2B>

(EcSiO_{3/2})ₓ(GpSiO_{3/2})_{y}(MeEtSiO_{2/2})_{z}(SiO_{4/2})_{w} <Formula 1-2C>

(EcSiO_{3/2})ₓ(GpSiO_{3/2})_{y}(GpMeSiO_{2/2})_{z}(SiO_{4/2})_{w} <Formula 1-2D>

(EcSiO_{3/2})ₓ(GpSiO_{3/2})_{y}(PhMeSiO_{2/2})_{z}(SiO_{4/2})_{w} <Formula 1-2E>

(wherein Formulae 1-2A to 1-2E, x, y, z, and w are as defined in Formula 1-2).

In a further embodiment, the siloxane resin represented by Formula 1 may be a siloxane resin includes a T unit, a T unit, and a Q unit, as represented by Formula 1-3:

(R¹SiO_{3/2})ₓ(R²SiO_{3/2})_{y}(SiO_{4/2})_{w} <Formula 1-3>

(wherein Formula 1-3, R¹ and R² are as defined in Formula 1, 0<x<1, 0<y≤0.50, 0<w<1, and x+y+w=1).

Specifically, in Formula 1-3, x, y and w are in the ranges of 0.30≤x<1.0, 0<y≤0.30, and 0<w≤0.40, more specifically 0.50≤x<1.0, 0<y≤0.20, and 0<w≤0.30, still more specifically 0.655≤x≤0.95, 0.01≤y≤0.15, and 0.01≤w≤0.20. Within these ranges, a window film formed of the composition can have improved hardness and flexibility. Specifically, the siloxane resin represented by Formula 1-3 may be (EcSiO_{3/2})ₓ(GpSiO_{3/2})_{y}(SiO_{4/2})_{w}.

The crosslinking agent contains a crosslinkable functional group, for example, an epoxy group or an oxetane group, and is cured together with the siloxane resin represented by Formula 1, thereby increasing hardness of the window film. The crosslinking agent may further contain at least one of a non-cyclic aliphatic hydrocarbon group, a cyclic aliphatic hydrocarbon group, and a hydrogenated aromatic hydrocarbon group, thereby further increasing flexibility of the coating layer. Specifically, the crosslinking agent may include at least one of a non-cyclic aliphatic epoxy monomer, a cyclic aliphatic epoxy monomer, a hydrogenated aromatic hydrocarbon epoxy monomer, and an oxetane monomer. Particularly, when the composition is coated onto a base layer formed of a polyimide film, the cyclic aliphatic epoxy monomer can realize a window film having high hardness, good flexibility, and good flexural reliability together with the siloxane resin represented by Formula 1.

Examples of the non-cyclic aliphatic epoxy monomer may include 1,4-butanediol diglycidyl ether, 1,6-hexanediol diglycidyl ether, neopentyl glycol diglycidyl ether, 1,7-octadiene diepoxide, trimethylolpropane triglycidyl ether, polyethylene glycol diglycidyl ether, glycerin triglycidyl ether, polypropylene glycol diglycidyl ether; polyglycidyl ethers of polyether polyols obtained by adding one or more alkylene oxides to aliphatic polyhydric alcohols, such as ethylene glycol, propylene glycol, glycerin, and the like; diglycidyl esters of aliphatic long-chain dibasic acids; monoglycidyl ethers of higher aliphatic alcohols; glycidyl ethers of higher fatty acids; epoxidized soybean oil; butyl epoxy stearate; octyl epoxy stearate; epoxidized linseed oil; and epoxidized polybutadiene.

The cyclic aliphatic epoxy monomer is a compound having at least one epoxy group in an alicyclic group. Specifically, the cyclic aliphatic epoxy monomer may include alicyclic epoxy carboxylates, alicyclic epoxy (meth)acrylates, and the like. More specifically, the cyclic aliphatic epoxy monomer may include (3,4-epoxycyclohexyl)methyl 3′,4′-epoxycyclohexanecarboxylate, diglycidyl 1,2-cyclohexanedicarboxylate, 2-(3,4-epoxycyclohexyl-5,5-spiro-3,4-epoxy)cyclohexane-meta-dioxane, bis(3,4-epoxycyclohexylmethyl)adipate, bis(3,4-epoxy-6-methylcyclohexylmethyl)adipate, 3,4-epoxy-6-methylcyclohexylmethyl-3′,4′-epoxy-6′-methylcyclohexanecarboxylate, ε-caprolactone-modified 3,4-epoxycyclohexylmethyl-3′,4′-epoxy-cyclohexanecarboxylate, trimethylcaprolactone-modified 3,4-epoxycyclohexylmethyl-3′,4′-epoxy-cyclohexanecarboxylate, β-Methyl-δ-valerolactone-modified 3,4-epoxycyclohexylmethyl-3′,4′-epoxycyclohexanecarboxylate, 1,4-cyclohexanedimethanol bis(3,4-epoxycyclohexanecarboxylate, ethyleneglycol di(3,4-epoxycyclohexylmethyl)ether, ethylenebis(3,4-epoxycyclohexanecarboxylate), 3,4-epoxycyclohexylmethyl (meth)acrylate, 4-vinylcyclohexen dioxide, vinylcyclohexene monoxide, 1,4-cyclohexanedimethanol diglycidyl ether, 2,2′-((1-methylethylidene)bis(cyclohexane-4,1-diyloxymethylene))bisoxirane, and the like.

The hydrogenated aromatic hydrocarbon epoxy monomer is a compound obtained by selective hydrogenation of an aromatic epoxy monomer in the presence of a catalyst under pressure. Examples of the aromatic epoxy monomer may include: bisphenol type epoxy resins such as diglycidyl ether of bisphenol A, diglycidyl ether of bisphenol F, and diglycidyl ether of bisphenol S; novolac type epoxy resins such as a phenol novolac epoxy resin, a cresol novolac epoxy resin, and a hydroxybenzaldehyde phenol novolac epoxy resin; polyfunctional epoxy resins, such as glycidyl ether of tetrahydroxyphenylmethane, glycidyl ether of tetrahydroxybenzophenone, and epoxidized polyvinyl phenol.

The oxetane monomer may include at least one of 3-methyloxetane, 2-methyloxetane, 2-ethylhexyloxetane, 3-oxetanol, 2-methyleneoxetane, 3,3-oxetanedimethanethiol, 4-(3-methyloxetan-3-yl) benzonitrile, N-(2,2-dimethylpropyl)-3-methyl-3-oxetanemethanamine, N-(1,2-dimethylbutyl)-3-methyl-3-oxetanemethanamine, (3-ethyloxetan-3-yl)methyl (meth)acrylate, 4-[(3-ethyloxetan-3-yl)methoxy] butan-1-ol, 3-ethyl-3-hydroxymethyloxetane, xylene bisoxetane, and 3-[ethyl-3[[(3-ethyloxetan-3-yl)]methoxy]methyl] oxetane, without being limited thereto.

The crosslinking agent may be present in an amount of about 0.1 parts by weight to about 50 parts by weight, specifically about 3 parts by weight to about 30 parts by weight, more specifically about 5 parts by weight to about 30 parts by weight, for example, 5 parts by weight, 6 parts by weight, 7 parts by weight, 8 parts by weight, 9 parts by weight, 10 parts by weight, 11 parts by weight, 12 parts by weight, 13 parts by weight, 14 parts by weight, 15 parts by weight, 16 parts by weight, 17 parts by weight, 18 parts by weight, 19 parts by weight, 20 parts by weight, 21 parts by weight, 22 parts by weight, 23 parts by weight, 24 parts by weight, 25 parts by weight, 26 parts by weight, 27 parts by weight, 28 parts by weight, 29 parts by weight, or 30 parts by weight, relative to 100 parts by weight of the siloxane resin represented by Formula 1. Within this range, the crosslinking agent can improve the flexibility and hardness of the coating layer.

The initiator serves to cure the siloxane resin represented by Formula 1 and the crosslinking agent and may include at least one of a photocationic initiator and a photo-radical initiator. The photocationic initiator may include any suitable photocationic initiator known to those skilled in the art. Specifically, the photocationic initiator may be an onium salt including a cation and an anion. Examples of the cation may include: diaryliodoniums such as diphenyliodonium, 4-methoxydiphenyliodonium, bis(4-methylphenyl)iodonium, bis(4-tert-butylphenyl)iodonium, bis(dodecylphenyl)iodonium, and (4-methylphenyl)[4-(2-methylpropyl)phenyl]iodonium; triarylsulfoniums such as triphenylsulfonium and diphenyl-4-thiophenoxyphenylsulfonium; and bis[4-(diphenylsulfonio)phenyl]sulfide. Examples of the anion may include hexafluorophosphate, tetrafluoroborate, hexafluoroantimonate, hexafluoroarsenate, and hexachloroantimonate. The initiator may be present in an amount of 0.1 parts by weight to 20 parts by weight, specifically 0.5 parts by weight to 10 parts by weight, for example, 0.5 parts by weight, 0.6 parts by weight, 0.7 parts by weight, 0.8 parts by weight, 0.9 parts by weight, 1 part by weight, 2 parts by weight, 3 parts by weight, 4 parts by weight, 5 parts by weight, 6 parts by weight, 7 parts by weight, 8 parts by weight, 9 parts by weight, or 10 parts by weight, relative to 100 parts by weight of the siloxane resin represented by Formula 1. Within this range, the siloxane resin can be sufficiently cured without deterioration in transparency of a window film due to residues of the initiator.

The composition for window films according to this embodiment may further include nanoparticles.

The nanoparticles can further increase hardness of the window film. The nanoparticles may include at least one of silica, aluminum oxide, zirconium oxide, and titanium oxide, without being limited thereto. The nanoparticles may also be subjected to surface treatment with a silicone compound for mixing with the siloxane resin. The nanoparticles may include spherical, flake, or amorphous particles and may have an average particle diameter of 1 nm to 200 nm, specifically 10 nm to 50 nm, without being limited thereto. The nanoparticles may be present in an amount of 0.1 parts by weight to 60 parts by weight, specifically 10 parts by weight to 50 parts by weight, for example, 5 parts by weight, 6 parts by weight, 7 parts by weight, 8 parts by weight, 9 parts by weight, 10 parts by weight, 11 parts by weight, 12 parts by weight, 13 parts by weight, 14 parts by weight, 15 parts by weight, 16 parts by weight, 17 parts by weight, 18 parts by weight, 19 parts by weight, 20 parts by weight, 21 parts by weight, 22 parts by weight, 23 parts by weight, 24 parts by weight, 25 parts by weight, 26 parts by weight, 27 parts by weight, 28 parts by weight, 29 parts by weight, 30 parts by weight, 31 parts by weight, 32 parts by weight, 33 parts by weight, 34 parts by weight, 35 parts by weight, 36 parts by weight, 37 parts by weight, 38 parts by weight, 39 parts by weight, 40 parts by weight 41 parts by weight, 4 parts by weight, 43 parts by weight, 44 parts by weight, 45 parts by weight, 46 parts by weight, 47 parts by weight, 48 parts by weight, 49 parts by weight, or 50 parts by weight, relative to 100 parts by weight of the siloxane resin represented by Formula 1. Within these ranges, the nanoparticles can increase hardness of a window film without affecting the surface roughness and transparency of the window film.

The composition for window films according to this embodiment may further include additives. The additives can provide additional functions to a window film. The additives may include any typical additives used for window films in the related art. Specifically, the additives may include at least one of a UV absorbent, a reaction inhibitor, an adhesion promoter, a thixotropic agent, a conductivity imparting agent, a color adjusting agent, a stabilizer, an antistatic agent, an antioxidant, and a leveling agent, without being limited thereto. The reaction inhibitor may include ethynylcyclohexane. The adhesion promoter may include an epoxy group or an alkoxysilyl group-containing silane compound. The thixotropic agent may include fumed silica and the like. The conductivity imparting agent may include a metal powder such as silver powder, copper powder, or aluminum powder. The color adjusting agent may include pigments, dyes, and the like. The UV absorber can increase light resistance of the window film. The UV absorber may include any typical UV absorber known to those skilled in the art. The additives may be present in an amount of about 0.01 parts by weight to about 5 parts by weight, specifically about 0.1 parts by weight to about 2.5 parts by weight, for example, 0.1 parts by weight, 0.5 parts by weight, 2.0 parts by weight, or 2.5 parts by weight, relative to 100 parts by weight of the siloxane resin represented by Formula 1. Within this range, the additive can provide desired effects without deterioration in hardness and flexibility of a window film.

The composition for window films according to this embodiment may further include a solvent to improve coatability or processability. The solvent may include at least one of methyl ethyl ketone, methyl isobutyl ketone, and propylene glycol monomethyl ether acetate, without being limited thereto.

The composition for window films according to this embodiment may have an index of refraction of about 1.4 to about 1.6, for example, 1.4, 1.5, or 1.6. Within this range, the composition for window films can have an appropriate index of refraction when directly coated onto a base layer, particularly a base layer formed of a polyimide resin, thereby realizing a window film having good optical transparency.

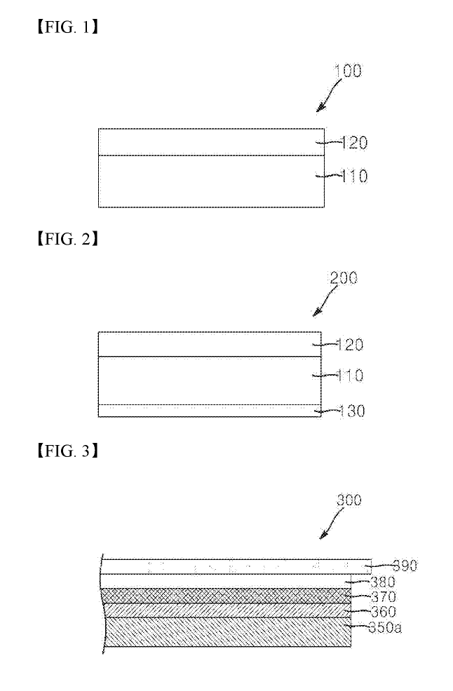

Next, a flexible window film according to one embodiment of the present invention will be described with reference to FIG. 1. FIG. 1 is a sectional view of a flexible window film according to one embodiment of the present invention.

Referring to FIG. 1, a flexible window film 100 according to this embodiment includes a base layer 110 and a coating layer 120, wherein the coating layer 120 may be formed of the composition for window films according to the present invention.

The base layer 110 can improve mechanical strength of the flexible window film 100 by supporting the flexible window film 100 and the coating layer 120. The base layer 110 may be attached to a display part, a touchscreen panel, or a polarizing plate through an adhesive layer or the like. The base layer 110 may be formed of an optically clear flexible resin. For example, the optically clear flexible resin may include at least one of polyester resins such as polyethylene terephthalate, polyethylene naphthalate, polybutylene terephthalate, and polybutylene naphthalate, polycarbonate resins, polyimide resins, polystyrene resins, and poly(meth)acrylate resins, such as poly(methyl methacrylate). Particularly, the base layer 110 formed of a polyimide resin may have an index of refraction of about 1.6 to about 1.7. The base layer 110 may have a thickness of about 10 μm to about 200 μm, specifically about 20 μm to about 150 μm, more specifically about 50 μm to about 100 μm, for example, 50 μm, 55 μm, 60 μm, 65 μm, 70 μm, 75 μm, 80 μm, 85 μm, 90 μm, 95 μm, or 100 μm. Within this range, the base layer can be used in the flexible window film.

The coating layer 120 may be formed on the base layer 110 to protect the base layer 110 and the display part, the touchscreen panel or the polarizing plate, and has high flexibility and high hardness to be used for a flexible display. The coating layer 120 may have a thickness of about 5 μm to about 100 μm, specifically about 5 μm to about 50 μm, for example, 5 μm, 10 μm, 15 μm, 20 μm, 25 μm, 30 μm, 35 μm, 40 μm, 45 μm, or 50 μm. Within this range, the coating layer can be used in the flexible window film. Although not shown in FIG. 1, functional surface layers such as an anti-reflection layer, an anti-glare layer, a hard coating layer, and an antistatic layer may be further formed on the other surface of the coating layer 120 to provide additional functions to the flexible window film. Although not shown in FIG. 1, the coating layer 120 may further be formed on the other surface of the base layer 110.

The flexible window film 100 is optically clear and thus can be used in a transparent display. Specifically, the flexible window film 100 may have a light transmittance of about 88% or more, specifically about 88% to about 100%, for example, 88%, 89%, 90%, 91%, 92%, 93%, 94%, 95%, 96%, 97%, 98%, 99%, or 100%, as measured in the visible range, specifically in the wavelength range of 400 nm to 800 nm. Within this range, the flexible window film 100 can be used as a flexible window film. The flexible window film 100 may have a pencil hardness of 3H or more, specifically 6H to 9H, for example, 6H, 7H, 8H, or 9H. Within this range, the flexible window film 100 can have hardness suitable for use as a window film.

The flexible window film 100 may have a radius of curvature of about 5 mm or less, specifically 0.1 mm to 5 mm, for example, 0.1 mm, 0.5 mm, 1.0 mm, 1.5 mm, 2.0 mm, 2.5 mm, 3.0 mm, 3.5 mm, 4.0 mm, 4.5 mm, or 5.0 mm. Within this range, the flexible window film 100 can have flexibility suitable for use as a flexible window film. The flexible window film 100 may have a curl of 5 mm or less, specifically 0.1 mm to 5 mm, for example, 0.1 mm, 0.5 mm, 1.0 mm, 1.5 mm, 2.0 mm, 2.5 mm, 3.0 mm, 3.5 mm, 4.0 mm, 4.5 mm, or 5.0 mm. Within this range, the flexible window film 110 can exhibit low curling suitable for use as a flexible window film. The flexible window film 100 may have a thickness of 50 μm to 300 μm, specifically about 50 μm to about 200 μm, for example, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, or 200 μm. Within this range, the flexible window film 110 can be used as a flexible window film.

Next, a flexible window film according to another embodiment of the present invention will be described with reference to FIG. 2. FIG. 2 is a sectional view of a flexible window film according to another embodiment of the invention.

Referring to FIG. 2, a flexible window film 200 according to this embodiment is substantially the same as the flexible window film 100 according to the above embodiment except that the flexible window film 200 further includes an adhesive layer 130. Thus, the following description will focus on the adhesive layer 130.

The adhesive layer 130 serves to attach a polarizing plate, a touchscreen panel, or a display part to a lower side of the flexible window film 200. The adhesive layer 130 may be formed of an adhesive composition including an adhesive resin such as a (meth)acrylic resin, a urethane resin, a silicone resin, and an epoxy resin, a curing agent, a photoinitiator, and a silane coupling agent. The (meth)acrylic resin is a (meth)acrylic copolymer having an alkyl group, a hydroxyl group, an aromatic group, a carboxylic acid group, an alicyclic group, or a hetero-alicyclic group, and may include any typical (meth)acrylic copolymer. Specifically, the (meth)acrylic resin may be formed of a monomer mixture including at least one of a (meth)acrylic monomer containing a C₁ to C₁₀ unsubstituted alkyl group, a (meth)acrylic monomer containing a C₁ to C₁₀ alkyl group having at least one hydroxyl group, a (meth)acrylic monomer containing a C₆ to C₂₀ aromatic group, a (meth)acrylic monomer containing a carboxylic acid group, a (meth)acrylic monomer containing a C₃ to C₂₀ alicyclic group, and a (meth)acrylic monomer containing a C₃ to C₁₀ hetero-alicyclic group. The curing agent is a polyfunctional (meth)acrylate and may include: bifunctional (meth)acrylates such as hexanediol diacrylate; trifunctional (meth)acrylates such as trimethylolpropane tri(meth)acrylate; tetrafunctional (meth)acrylates such as pentaerythritol tetra(meth)acrylate; pentafunctional (meth)acrylates such as dipentaerythritol penta(meth)acrylate; and hexafunctional (meth)acrylates such as dipentaerythritol hexa(meth)acrylate, without being limited thereto. The photoinitiator is a typical photoinitiator and may include the photo-radical initiator as described above. The silane coupling agent may include an epoxy group-containing silane coupling agent such as 3-glycidoxypropyltrimethoxysilane. The adhesive composition may include 100 parts by weight of the (meth)acrylic resin, about 0.1 parts by weight to about 30 parts by weight of the curing agent, about 0.1 parts by weight to about 10 parts by weight of the photoinitiator, and about 0.1 parts by weight to about 20 parts by weight of the silane coupling agent. Within these ranges, the flexible window film can have good adhesion to a display part, a touchscreen panel or a polarizing plate. The adhesive layer 130 may have a thickness of about 10 μm to about 100 μm, for example, 10 μm, 20 μm, 30 μm, 40 μm, 50 μm, 60 μm, 70 μm, 80 μm, 90 μm, or 100 μm. Within this range, the flexible window film can have sufficient adhesion to an optical device such as a polarizing plate.

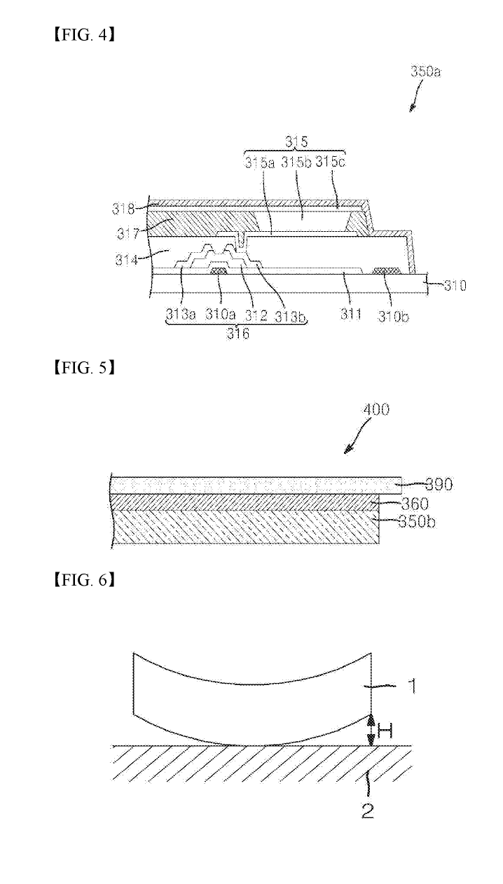

Next, a flexible display according to one embodiment of the present invention will be described with reference to FIG. 3 and FIG. 4. FIG. 3 is a sectional view of a flexible display according to one embodiment of the present invention and FIG. 4 is a sectional view of one embodiment of a display part shown in FIG. 3.

Referring to FIG. 3, a flexible display 300 according to one embodiment includes a display part 350a, an adhesive layer 360, a polarizing plate 370, a touchscreen panel 380, and a flexible window film 390, which may include the flexible window film according to the embodiments of the invention. Although FIG. 3 shows the structure of the flexible display in which the display part 350a, the adhesive layer 360, the polarizing plate 370, the touchscreen panel 380, and the flexible window film 390 are sequentially, it should be understood that the present invention is not limited thereto and a flexible display according to another embodiment of the invention may have a structure in which the display part 350a, the touchscreen panel 380, the polarizing plate 370, and the flexible window film 390 are sequentially formed. In this embodiment, since the touchscreen panel 380 is formed together with the display part 350a, the flexible display has a smaller thickness and higher brightness than the flexible display according to the above embodiment, thereby exhibiting better visibility.

The display part 350a serves to drive the flexible display 300 and may include a substrate and an optical device formed on the substrate, wherein the optical device may include an OLED, an LED, or an LCD. FIG. 4 is a sectional view of one embodiment of the display part shown in FIG. 3. Referring to FIG. 4, the display part 350a may include a lower substrate 310, a thin film transistor 316, an organic light emitting diode 315, a flattening layer 314, a protective film 318, and an insulating layer 317. The lower substrate 310 supports the display part 350a, and the thin film transistor 316 and the organic light emitting diode 315 may be formed on the lower substrate 310. In addition, a flexible printed circuit board (FPCB) may be formed on the lower substrate 310 to drive the touchscreen panel 380. The flexible printed circuit board may be further provided with a timing controller, a power source, and the like in order to drive an array of organic light emitting diodes. The lower substrate 310 may include a substrate formed of a flexible resin. Specifically, the lower substrate 310 may include a flexible substrate such as a silicon substrate, a polyimide substrate, a polycarbonate substrate, and a polyacrylate substrate, without being limited thereto. In a display region of the lower substrate 310, plural pixel domains are defined by plural driving wires (not shown) and plural sensor wires (not shown) intersecting each other, and an array of organic light emitting diodes each including the thin film transistor 316 and the organic light emitting diode 315 connected to the thin film transistor 316 may be formed in each of the pixel domains. In a non-display region of the lower substrate, a gate driver may be formed in the form of a gate-in-panel to apply electrical signals to the driving wires. A gate-in-panel circuit may be formed at one or both sides of the display region. The thin film transistor 316 controls electric current flowing through a semiconductor by application of an electric field perpendicular thereto and may be formed on the lower substrate 310. The thin film transistor 316 may include a gate electrode 310a, a gate insulation layer 311, a semiconductor layer 312, a source electrode 313a, and a drain electrode 313b. The thin film transistor 316 may be an oxide thin film transistor using an oxide, such as indium gallium zinc oxide (IGZO), ZnO, or TiO, as the semiconductor layer 312, an organic thin film transistor using an organic material as the semiconductor layer, an amorphous silicon thin film transistor using amorphous silicon as the semiconductor layer, or a polycrystalline silicon thin film transistor using polycrystalline silicon as the semiconductor layer. The flattening layer 314 covers the thin film transistor 316 and the circuit 310b to flatten upper surfaces of the thin film transistor 316 and the circuit 310b such that the organic light emitting diode 315 can be formed thereon. The flattening layer 314 may be formed of a spin-on-glass (SOG) film, a polyimide polymer, or a polyacrylic polymer, without being limited thereto. The organic light emitting diode 315 realizes a display through self-emission, and may include a first electrode 315a, an organic light emitting layer 315b, and a second electrode 315c, which are sequentially stacked in the stated order. Adjacent organic light emitting diodes may be isolated from each other by the insulating layer 317. The organic light emitting diode 315 may have a bottom emission structure in which light from the organic light emitting layer 315b is discharged through the lower substrate or may have a top emission structure in which light from the organic light emitting layer 315b is discharged upward. The protective film 318 covers the organic light emitting diodes 315 to protect the organic light emitting diodes 315. The protective film 318 may be formed of an inorganic material such as SiOₓ, SiNₓ, SiC, SiON, SiONC, amorphous carbon (a-C), or an organic material such as (meth)acrylates, epoxy polymers, and imide polymers.

Referring again to FIG. 3, the adhesive layer 360 attaches the display part 350a to the polarizing plate 370, and may be formed of an adhesive composition including a (meth)acrylate resin, a curing agent, an initiator, and a silane coupling agent.

The polarizing plate 370 can realize polarization of internal light or prevent reflection of external light to realize a display, or can increase contrast of the display. The polarizing plate may be composed of a polarizer alone. Alternatively, the polarizing plate may include a polarizer and a protective film formed on one or both surfaces of the polarizer. As the polarizer and the protective film, any typical polarizer and protective film known to those skilled in the art may be used.

The touchscreen panel 380 generates electrical signals through detection of variation in capacitance. The touchscreen panel 380 is formed by patterning a flexible conductor. The conductor for the touchscreen panel 380 may include metal nanowires, conductive polymers, and carbon nanotubes, without being limited thereto.

The flexible window film 390 may be disposed at the outermost side of the flexible display 300 to protect the flexible display.

Although not shown in FIG. 3, adhesive layers may further be formed between the polarizing plate 370 and the touchscreen panel 380 and/or between the touchscreen panel 380 and the flexible window film 390. The adhesive layers are the same as described above. In addition, although not shown in FIG. 3, a polarizing plate may be further disposed under the display part 350a to realize polarization of internal light.

Next, a flexible display according to another embodiment of the present invention will be described with reference to FIG. 5. FIG. 5 is a sectional view of a flexible display according to another embodiment of the present invention.

Referring to FIG. 5, a flexible display 400 according to another embodiment is substantially the same as the flexible display 300 according to the above embodiment except that the flexible display 400 can be driven only by a display part 350b without the polarizing plate and the touchscreen panel. The display part 350b may include a substrate and an optical device formed on the substrate, wherein the optical device may include an LCD, an OLED, or an LED. Alternatively, the display part 350b may have a touchscreen panel formed therein.

Although FIG. 3 and FIG. 5 show the flexible displays, it should be understood that the present invention is not limited thereto and the window film according to the present invention may also be used in non-flexible displays.

Next, a method of preparing the siloxane resin represented by Formula 1 will be described.

The siloxane resin represented by Formula 1 may be prepared by hydrolysis and condensation of a monomer mixture including a first silicone monomer represented by Formula 2 and a second silicone monomer represented by Formula 3 or a monomer mixture further including at least one of a third silicone monomer represented by Formula 4 and a fourth silicone monomer represented by Formula 5 in addition to the first silicone monomer and the second silicone monomer. The silicone monomers may be used alone or as a mixture thereof.

Si(R¹)(R⁵)(R⁶)(R⁷) <Formula 2>

Si(R²)(R⁸)(R⁹)(R¹⁰) <Formula 3>

Si(R³)(R⁴)(R¹¹)(R¹²) <Formula 4>

(wherein Formula 1, Formula 2, Formula 3 and Formula 4, R¹, R², R³ and R⁴ are as defined in Formula 1, and R⁵, R⁶, R⁷, R⁸, R⁹, R¹⁰, R¹¹ and R¹² are each independently a halogen, a hydroxyl group, or a C₁ to C₁₀ alkoxy group.)

Si(OR¹³)₄ <Formula 5>

(wherein Formula 5, R¹³ is a C₁ to C₁₀ alkoxy group.)

Examples of the first silicone monomer may include 2-(3,4-epoxycyclohexyl)ethyltrimethoxysilane, (3,4-epoxycyclohexyl)methyltrimethoxysilane, 2-(3,4-epoxycyclohexyl)ethyltriethoxysilane, and (3,4-epoxycyclohexyl)methyltriethoxysilane. Examples of the second silicone monomer may include (3-glycidoxypropyl)trimethoxysilane and (3-glycidoxypropyl)triethoxysilane. Examples of the third silicone monomer may include dimethyldimethoxysilane, 2-(3,4-epoxycyclohexyl)ethylmethyldiethoxysilane, and (3-glycidoxypropyl)methyldiethoxysilane. Specifically, the fourth silicone monomer may include at least one of tetramethoxysilane, tetraethoxysilane, tetrapropoxysilane, tetrabutoxysilane, and tetraisopropoxysilane. In one embodiment, the first silicone monomer may be present in an amount of 70 mol % or more to less than 100 mol %, 80 mol % or more to less than 100 mol %, or 85 mol % to 99 mol %, for example, 85 mol %, 86 mol %, 87 mol %, 88 mol %, 89 mol %, 90 mol %, 91 mol %, 92 mol %, 93 mol %, 94 mol %, 95 mol %, 96 mol %, 97 mol %, 98 mol %, or 99 mol %, in the monomer mixture. The second silicone monomer may be present in an amount of more than 0 mol % to 30 mol % or less, more than 0 mol % to 20 mol % or less, or 1 mol % to 15 mol %, for example, 1 mol %, 2 mol %, 3 mol %, 4 mol %, 5 mol %, 6 mol %, 7 mol %, 8 mol %, 9 mol %, 10 mol %, 11 mol %, 12 mol %, 13 mol %, 14 mol %, or 15 mol %, in the monomer mixture. Within these ranges, the composition can realize a window film having high pencil hardness, good appearance, low radius of curvature, and good flexibility.

Hydrolysis and condensation of the monomer mixture may be performed by any typical method for preparing siloxane resins. Hydrolysis of the monomer mixture may include reacting the monomer mixture with a mixture of water and at least one of specific acids and bases. Examples of the acids may include HCl, HNO₃, and acetic acid, and example of the bases may include NaOH and KOH. Hydrolysis of the monomer mixture may be carried out at about 20° C. to about 100° C. for about 10 minutes to about 10 hours and condensation of the monomer mixture may be carried out at about 20° C. to about 100° C. for about 10 minutes to about 12 hours under the same conditions as in hydrolysis. When hydrolysis and condensation of the monomer mixture are performed under these conditions, production efficiency of the siloxane resin represented by Formula 1 can be improved.

Next, a method of preparing a flexible window film according to one embodiment of the present invention will be described.

A method of preparing a flexible window film according to this embodiment may include coating the composition for window films according to the present invention onto a base layer 110, followed by curing. Here, the composition for window films may be coated onto the base layer 110 to a thickness of 5 μm to 100 μm, specifically about 5 μm to about 80 μm, for example, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, or 80 μm, by bar coating, spin coating, dip coating, roll coating, flow coating, or die coating, without being limited thereto. Within this range of coating thickness, a desired coating layer can be obtained and the window film can have good properties in terms of hardness, flexibility, and reliability. Here, curing of the composition may be performed by at least one of photo-curing and thermal curing. Photo-curing may be performed through UV irradiation at a wavelength of about 400 nm or less at a fluence of about 10 mJ/cm² to about 1000 mJ/cm², and thermal curing may be performed through heat treatment at about 40° C. to about 200° C. for about 1 to 30 hours. When curing of the composition for window films is performed under these conditions, the composition for window films can be sufficiently cured. In addition, the composition for window films coated onto the base layer 110 may be subjected to drying prior to the curing process to prevent increase in surface roughness of the coating layer due to long-term photo-curing and thermal curing. Here, drying of the composition for window films may be performed at about 40° C. to about 200° C. for about 1 minute to about 30 hours, without being limited thereto.

Next, the present invention will be described in more detail with reference to some examples. It should be understood that these examples are provided for illustration only and are not to be in any way construed as limiting the present invention.

### Example 1

Into a 1 L 3-neck flask, 400 g of a silicone monomer mixture including 95 mol % of 2-(3,4-epoxycyclohexyl)ethyltrimethoxysilane (KBM-303, Shin-Etsu Chemical Co., Ltd.) and 5 mol % of (3-glycidoxypropyl)trimethoxysilane (KBM-403, Shin-Etsu Chemical Co., Ltd.) was placed. Then, 0.1 mol % of KOH (based on the silicone monomer mixture) and 1 equivalent of water (based on the silicone monomers) were added to the silicone monomer mixture, and the resulting product was stirred at 65° C. for 8 hours, followed by washing with toluene and concentration, thereby preparing a siloxane resin represented by (EcSiO_{3/2})_{0.95}(GpSiO_{3/2})_{0.05} (weight average molecular weight measured by GPC: 5,500).

Then, 100 parts by weight of the prepared siloxane resin was mixed with 10 parts by weight of a crosslinking agent, 3,4-epoxycyclohexylmethyl 3′,4′-epoxycyclohexanecarboxylate (CY-179, CIBA Corporation), 3 parts by weight of an initiator, (4-methylphenyl)[4-(2-methylpropyl)phenyl]iodonium hexafluorophosphate (Irgacure-250, BASF Corporation), and a solvent, methyl ethyl ketone, thereby preparing a composition for window coating layers (total amount excluding solvent: 70% by weight). The prepared composition for window coating layers was coated onto one surface of a transparent polyimide film (thickness: 50 μm), as a base layer, using a Meyer bar, followed by drying at 80° C. for 5 minutes, UV irradiation at a fluence of 1000 mJ/cm², and heat treatment at 100° C. for 24 hours, thereby preparing a window film having a window coating layer (thickness: 50 μm) formed on one surface of the transparent polyimide film.

### Examples 2 to 4 and Comparative Examples 1 to 3

A window film was prepared in the same manner as in Example 1 except that a molar ratio of 2-(3,4-epoxycyclohexyl)ethyltrimethoxysilane to (3-glycidoxypropyl)trimethoxysilane was changed as listed in Table 1.

Each of the window films prepared in Examples and Comparative Examples was evaluated as to the following properties. Results are shown in Table 1.

(1) Pencil hardness: Pencil hardness was measured on a coating layer of each of the window films using a pencil hardness tester (Heidon Co., Ltd.) in accordance with JIS K5400. Pencil hardness was measured using pencils of 6B to 9H (Mitsubishi Co., Ltd.). Specifically, pencil hardness was measured under a load of 1 kg on the coating layer, a scratch angle of 45°, and a scratch speed of 60 mm/min. When the coating layer had one or more scratches after being tested 5 times using a certain pencil, pencil hardness was measured again using another pencil having one-level lower pencil hardness than the previous pencil. A pencil hardness value allowing no scratch to be observed all five times on the coating layer was taken as pencil hardness of the coating layer.

(2) Curling: Referring to FIG. 6, each of the flexible window films 1 was cut to a size of 10 cm×10 cm (width×length) and then left on a floor surface 2 at 25° C. and 40% RH, followed by measurement of a maximum height (H) of an edge of the window film from the floor surface 2, and then the measured values were averaged.

(3) Radius of curvature: Each of the window films (width×length×thickness: 3 cm×15 cm×100 μm) was wound around a jig for measurement of radius of curvature (CFT-200R, COVOTECH Co., Ltd kept wound for 5 seconds or more, unwound, and then observed with the naked eye to determine whether the window film had cracks. In measurement of the radius of curvature, the window film was wound around the jig such that the coating layer contacted the jig. The radius of curvature was determined by a minimum radius of a jig causing no cracks on the window film, as measured while gradually decreasing the diameters of jigs from a jig having the maximum diameter in the compressive direction.

(4) Flexural reliability: Each of the window films (length×width×thickness: 20 cm×2 cm×100 μm) was secured to a jig for measurement of radius of curvature (CFT-200R, COVOTECH Co., Ltd.), as described below, and folded repeatedly to evaluate flexural reliability. Here, the window film was folded at a rate of 0.5 times per second. Specifically, the window film was secured to the jig at room temperature (23° C. to 28° C.) such that the window coating layer contacted the jig, folded such that the window coating layer had a radius of curvature of 3 mm, and then left folded for 1 second. This procedure was repeated 200,000 times, followed by observation of cracks on the window coating layer with the naked eye. When no crack was observed, the window film was rated as o (good flexural reliability), and, when cracks were observed, the window film was rated as x.

TABLE 1

| | | Example | | | | Comparative example | | |
|---|---|---|---|---|---|---|---|---|
| | | 1 | 2 | 3 | 4 | 1 | 2 | 3 |
| Silicone | 2-(3,4- | 95 | 90 | 85 | 99 | 100 | — | 48 |
| monomer | epoxycyclohexyl) | | | | | | | |
| (mol %) | Ethyltrimethoxysilane | | | | | | | |
| | (3- | 5 | 10 | 15 | 1 | — | 100 | 52 |
| | glycidoxypropyl) | | | | | | | |
| | trimethoxysilane | | | | | | | |
| Siloxane | X in Formula 1-1 | 0.95 | 0.90 | 0.85 | 0.99 | 1.0 | — | 0.48 |
| resin | Y in Formula 1-1 | 0.05 | 0.10 | 0.15 | 0.01 | — | 1.0 | 0.52 |

| | | | | | | | |
|---|---|---|---|---|---|---|---|
| Crosslinking agent | 10 | 10 | 10 | 10 | 10 | 10 | 10 |
| (part by weight) | | | | | | | |
| Initiator | 3 | 3 | 3 | 3 | 3 | 3 | 3 |
| (part by weight) | | | | | | | |
| Weight average molecular | 5500 | 5800 | 6100 | 5100 | — | — | — |
| weight of siloxane resin | | | | | | | |
| Pencil hardness | 8H | 8H | 8H | 8H | 8H | 7H | 8H |
| Curling (mm) | 2 | 2.5 | 3.4 | 2 | 2 | Not | Not |
| | | | | | | measur- | measur- |
| | | | | | | able | able |
| Radium of curvature (mm) | 1.5 | 1.0 | 1.0 | 2 | 2.5 | 1.0 | 1.0 |
| Flexural reliability | ∘ | ∘ | ∘ | ∘ | x | ∘ | ∘ |

As shown in Table 1, it can be seen that the composition for window films according to the present invention could realize a flexible window film which had high pencil hardness, low curling, low radius of curvature, good flexibility, and good flexural reliability.

Conversely, the composition for window films of Comparative Example 1, which included only the EcSiO_{3/2} unit, had poor flexural reliability. In addition, the composition for window films of Comparative Example 2, which included only the GpSiO_{3/2} unit, and the composition for window films of Comparative Example 3, in which the amount of the GpSiO_{3/2} unit exceeded the amount of the EcSiO_{3/2} unit, suffered from severe curling, making measurement thereof impossible, and thus were not suitable for use as a window film.

It should be understood that various modifications, changes, alterations, and equivalent embodiments can be made by those skilled in the art without departing from the spirit and scope of the invention.

1. A composition for window films, comprising:
a siloxane resin represented by Formula 1; a crosslinking agent; and an initiator.
(R¹SiO_{3/2})ₓ(R²SiO_{3/2})_{y}(R³R⁴SiO_{2/2})_{z}(SiO_{4/2})_{w} <Formula 1>
(wherein Formula 1, R¹ is an alicyclic epoxy group-containing functional group, R² is a glycidyl group-containing functional group, R³ and R⁴ are each independently hydrogen, an alicyclic epoxy group-containing functional group, a glycidyl group-containing functional group, an unsubstituted or substituted C₁ to C₂₀ alkyl group, an unsubstituted or substituted C₅ to C₂₀ cycloalkyl group, or an unsubstituted or substituted C₆ to C₂₀ aryl group, 0<x<1, 0<y≤0.5, 0≤z<1, 0≤w<1, and x+y+z+w=1.)

2. The composition for window films according to claim 1, wherein y is in the range of 0.01≤y≤0.15.

3. The composition for window films according to claim 1, wherein the siloxane resin represented by Formula 1 comprises a siloxane resin represented by (EcSiO_{3/2})ₓ(GpSiO_{3/2})_{y} (where Ec is a 2-(3,4-epoxycyclohexyl)ethyl group, Gp is a 3-glycidoxypropyl group, 0.5≤x<1, 0<y≤0.5, and x+y=1).

4. The composition for window films according to claim 1, wherein the crosslinking agent comprises at least one of a non-cyclic aliphatic epoxy monomer, a cyclic aliphatic epoxy monomer, a hydrogenated aromatic hydrocarbon epoxy monomer, and an oxetane monomer.

5. The composition for window films according to claim 1, wherein the composition has an index of refraction of about 1.4 to about 1.6.

6. A flexible window film comprising:
a base layer; and
a coating layer formed on the base layer,
wherein the coating layer is formed of the composition for window films according to claim 1.

7. The flexible window film according to claim 6, further comprising: an adhesive layer formed on the other surface of the base layer.

8. The flexible window film according to claim 6, wherein the flexible window film has a radius of curvature of about 5.0 mm or less.

9. A flexible display comprising the flexible window film according to claim 6.

10. The flexible display according to claim 9, comprising: a display part; an adhesive layer formed on the display part; a polarizing plate formed on the adhesive layer; a touchscreen panel formed on the polarizing plate; and the flexible window film formed on the touchscreen panel.

11. The flexible display according to claim 9, comprising: a display part; a touchscreen panel formed on the display part; a polarizing plate formed on the touchscreen panel; and the flexible window film formed on the polarizing plate.

12. The flexible display according to claim 9, comprising: a display part; an adhesive layer formed on the display part; and the flexible window film formed on the adhesive layer.

13. The flexible display according to claim 12, wherein the display part further comprises a polarizing plate formed on an upper surface or lower surface thereof.
